(19) United States
(12) Patent Application Publication
(10) Pub. No.: US 2018/0146075 A1
(43) Pub. Date: May 24, 2018

(54) NETWORK COMMUNICATION PROTOCOL TRANSLATION SYSTEM AND METHOD

(71) Applicant: Institute For Information Industry, Taipei (TW)

(72) Inventors: Chao-Hsien LEE, Taipei City (TW); Ying-Hsun LAI, Kaohsiung City (TW); Chi-Cheng CHUANG, Kaohsiung City (TW)

(21) Appl. No.: 15/369,224

(22) Filed: Dec. 5, 2016

(30) Foreign Application Priority Data
Nov. 23, 2016 (TW) 105138404

(51) Int. Cl. H04L 29/06; H04L 12/931

(52) U.S. Cl. CPC H04L 69/22; H04L 49/35; H04L 69/18; H04L 69/08

(57) ABSTRACT

A network communication protocol translation system and method are provided. The SDN controller receives a first packet from the SDN switch. The first packet records the name of the source protocol of the source apparatus and the name of the destination protocol of the destination apparatus. The source protocol and the destination protocol are different. The SDN controller forwards the first packet to the cross proxy. The cross proxy translates the first packet that conforms to the source protocol into the second packet that conforms to the destination protocol and transmits the second packet to the destination apparatus. The cross proxy receives the third packet from the destination apparatus, translates the third packet that conforms to the destination protocol into the fourth packet that conforms to the source protocol, and transmits the fourth packet to the source apparatus.

### PRIORITY

This application claims priority to Taiwan Patent Application No. 105138404 filed on Nov. 23, 2016, which is hereby incorporated by reference in its entirety herein.

### FIELD

The present invention relates to a network communication protocol translation system and method. More particularly, the present invention relates to a network communication protocol translation system and method capable of transparent translation.

### BACKGROUND

Technologies regarding Internet of Things (IoT) have been developed rapidly in recent years. Due to various kinds of needs and considerations, a lot of network communication protocols have been designed. These network communication protocols are different in terms of field formats as well as architectures. Currently, architectures adopted by the IoT communication protocols may be generally divided into two categories. According to the IoT network communication protocols of the first category, a user equipment (UE) can communicate with a server directly. The Constrained Application Protocol (CoAP) is an example of the first category. Briefly speaking, if the UE transmits a request signal to the server, the server will transmit a reply signal to the UE in response. According to the IoT network communication protocols of the second category, the UE cannot directly communicate with the server; that is, they communicate with each other through a broker. The Message Queuing Telemetry Transport (MQTT) protocol is an example of the second category. Briefly speaking, the UE has to subscribe information to the broker, the server pushes new information to the broker periodically or aperiodically, and data is provided by the broker to the UE.

Since the network communication protocols are different in both field formats and architectures, it is difficult for apparatuses having different network communication protocols to achieve cross-protocol communication and exchange information. For example, a packet that is to be transmitted to a server according to one network communication protocol may have to be transmitted to a broker according to another network communication protocol. Due to the diversities, the conventional technology only provides field translation between different network communication protocols and do nothing regarding translation in architecture. Under the circumstance, all conventional heterogeneous IoT environments adopt a centralized architecture. Briefly speaking, data collected by every apparatus in a heterogeneous IoT environment is transmitted to a cloud server. When a certain apparatus requires some data, the apparatus makes a request to the cloud server which then translates the required data stored therein into data conforming to the network communication protocol used by the apparatus. Since the centralized architecture is adopted, the cloud server usually bears an excessive burden.

In view of this, a network communication protocol translation mechanism that is transparent and adopts a distributed architecture is still needed in the art.

### SUMMARY

The disclosure includes a network communication protocol translation system. The network communication protocol translation system may comprise a cross proxy and a software-defined network (SDN) controller. The SDN controller is configured to receive a first packet from an SDN switch and forward the first packet to the cross proxy. The first packet records a name of a source protocol of a source apparatus and a name of a destination protocol of a destination apparatus, wherein the source protocol and the destination protocol are different. The cross proxy generates a second packet by translating a first header of the first packet into a second header and transmits the second packet to the destination apparatus. The first header conforms to the source protocol, while the second header conforms to the destination protocol. The cross proxy server further receives a third packet from the destination apparatus, generates a fourth packet by translating a third header of the third packet into a fourth header, and transmits the fourth packet to the source apparatus. The third header conforms to the destination protocol, while the fourth header conforms to the source protocol.

The disclosure also includes a network communication protocol translation method. The network communication protocol translation method may comprise the following steps of: (a) receiving a first packet from a SDN switch by an SDN controller, (b) forwarding the first packet to a cross proxy by the SDN controller, wherein the first packet records a name of a source protocol of a source apparatus and a name of a destination protocol of a destination apparatus and the source protocol and the destination protocol are different, (c) generating a second packet by translating a first header of the first packet into a second header by the cross proxy, (d) transmitting the second packet to the destination apparatus by the cross proxy, wherein the first header conforms to the source protocol and the second header conforms to the destination protocol, (e) receiving a third packet from the destination apparatus by the cross proxy, (f) generating a fourth packet by translating a third header of the third packet into a fourth header by the cross proxy, and (g) transmitting the fourth packet to the source apparatus by the cross proxy, wherein the third header conforms to the destination protocol and the fourth header conforms to the source protocol.

According to the disclosed examples, the SDN switch, the SDN controller, and the cross proxy take charge of main related operations when the source apparatus requests data from a destination apparatus adopting a different communication protocol. If the SDN switch already has a routing rule, the packet transmitted by the source apparatus is processed according to the routing rule. If the SDN switch does not have the routing rule, the packet from the source apparatus is forwarded to the SDN controller. The SDN controller formulates a routing rule between the source apparatus and the destination apparatus, transmits the routing rule to the SDN switch for subsequent use, and forwards the packet to the cross proxy. The cross proxy then translates the packet transmitted between the source apparatus and the destination apparatus. Through the aforesaid operations, the source apparatus can adopt its original communication protocol to communicate with apparatuses conforming to other communication protocols, while the destination apparatus also adopts its original communication protocol to communicate with the source apparatus. Therefore, the present invention is able to provide a heterogeneous network environment that is capable of transparent translation and using a distributed architecture.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1A illustrates a heterogeneous network environment of the first embodiment;

FIG. 1B illustrates a schematic view of an extended Uniform Resource Identifier (URI);

FIG. 1C illustrates a specific example conforming to the format shown in FIG. 1B;

FIG. 2 illustrates a heterogeneous network environment of the second embodiment;

FIG. 3 illustrates the flowchart of a network communication protocol translation method of the third embodiment; and

FIG. 4 illustrates the flowchart of a network communication protocol translation method of the fourth embodiment.

### DETAILED DESCRIPTION

In the following description, network communication protocol translation system and method according to the present invention will be explained with reference to example embodiments thereof. However, these example embodiments are not intended to limit the present invention to any environment, applications, or implementations described in these example embodiments. Therefore, description of these example embodiments is only for purpose of illustration rather than to limit the present invention.

It shall be appreciated that, in the following embodiments and the attached drawings, elements unrelated to the present invention are omitted from depiction. In addition, dimensions of and dimensional relationships among individual elements in the attached drawings are provided only for illustration but not to limit the scope of the present invention.

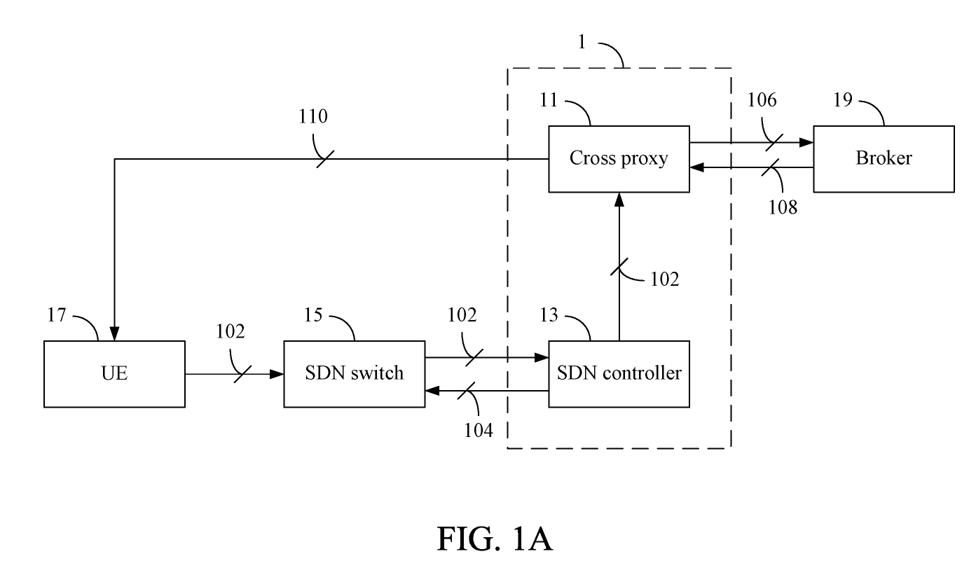

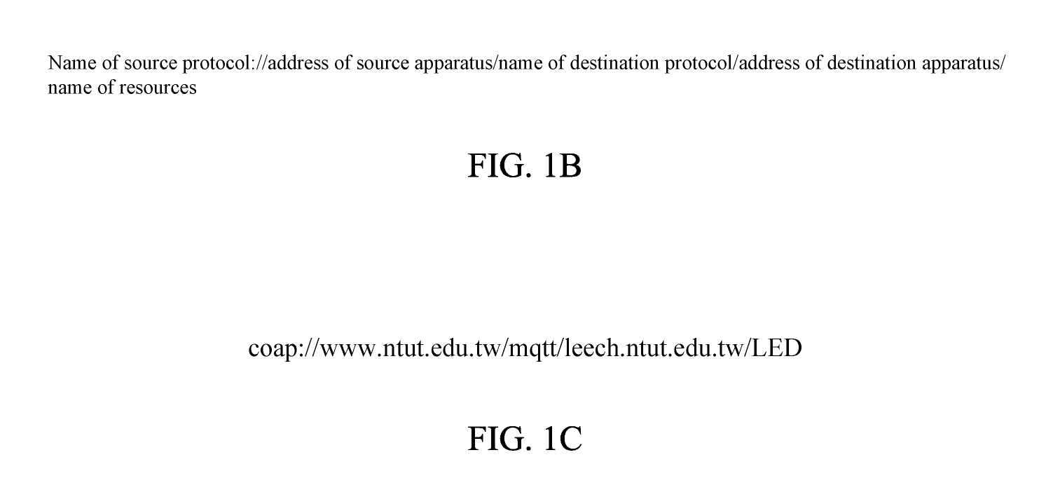

A first embodiment of the present invention is a network communication protocol translation system 1, which is suitable for use in a heterogeneous network environment (e.g., a heterogeneous IoT environment) illustrated in FIG. 1A. The network communication protocol translation system 1 comprises a cross proxy 11 and a Software-Defined Network (SDN) controller 13. The heterogeneous network environment comprises the network communication protocol translation system 1 (comprising the cross proxy 11 and the SDN controller 13), a SDN switch 15, a User Equipment (UE, e.g., a terminal) 17, and a broker (e.g., a server having a broker function) 19.

In some embodiments, each of the cross proxy 11 and the SDN controller 13 is an individual apparatus having an electronic computing capability (e.g., a server). For those embodiments, each of the cross proxy 11 and the SDN controller 13 has a processor for executing necessary operations and each of them has a transceiver for transceiving signals and data. In some other embodiments, the cross proxy 11 and the SDN controller 13 may be integrated into an apparatus having an electronic computing capability (e.g., a server). In such embodiments, the apparatus that comprises the cross proxy 11 and the SDN controller 13 comprises a processor for executing necessary operations and a transceiver for transceiving signals and data.

The SDN switch 15 can execute operations of conventional network switches and has the functions of conventional network switches. In some embodiments, the network communication protocol translation system 1 also comprises the SDN network switch 15. Nevertheless, the SDN network switch 15 is external to the cross proxy 11 and the SDN controller 13 (i.e., the SDN network switch 15 is not integrated into the same apparatus as the cross proxy 11 and the SDN controller 13).

In this embodiment, the UE 17 adopts a first communication protocol, the broker 19 adopts a second communication protocol, and the first communication protocol and the second communication protocol are different. According to the specification of the first communication protocol, the UE 17 requests data from a server directly. For example, the first communication protocol may be the Constrained Application Protocol (CoAP) and the UE 17 may be a CoAP apparatus. According to the specification of the second communication protocol, a UE cannot request data from a server (not shown) directly. Instead, the UE according to the second communication protocol obtain from the broker 19 the data that the server previously pushed to the broker 19. For example, the second communication protocol may be a Message Queuing Telemetry Transport (MQTT) protocol and the broker 19 may be a MQTT broker. In this embodiment, the UE 17 requests data from the broker 19, so the UE 17 may be termed as a source apparatus, the broker 19 may be termed as a destination apparatus, the first communication protocol may be termed as a source protocol, and the second communication protocol may be termed as a destination protocol.

In this embodiment, the UE 17 learns that the heterogeneous network environment comprises the broker 19 by broadcasting. The UE 17 views the broker 19 as a server and transmits a packet 102 to request data from the broker 19. The packet 102 records a name of the source protocol (i.e., the first communication protocol adopted by the UE 17), an address (e.g., an Internet Protocol (IP) address) of the source device (i.e., the UE 17), a name of the destination protocol (i.e., the second communication protocol adopted by the broker 19), and an address (e.g., an IP address) of the destination apparatus (i.e., the broker 19).

The SDN switch 15 receives the packet 102 transmitted by the UE 17 and parses the packet 102. After parsing the packet 102, the SDN switch 15 determines that the source protocol and the destination protocol recorded in the packet 102 are different and determines that the SDN switch 15 itself has no routing rule (not shown) between the UE 17 (i.e., the source apparatus) and the broker 19 (i.e., the destination apparatus). In some embodiments, the SDN switch 15 makes the aforementioned two determinations by parsing an extended Uniform Resource Identifier (URI) in the packet 102. The extended URI comprises the name of the source protocol, the address of the source apparatus, the name of the destination protocol, and the address of the destination apparatus. The extended URI is an extension of the conventional URI. For example, the extended URI may have a format illustrated in FIG. 1B. FIG. 1C illustrates a specific example conforming to the format of FIG. 1B.

The SDN switch 15 forwards the packet 102 to the SDN controller 13 after determining that the SDN switch 15 itself has no routing rule between the UE 17 (i.e., the source apparatus) and the broker 19 (i.e., the destination apparatus). The SDN controller 13 receives the packet 102 from the SDN switch 15 and then forwards the packet 102 to the cross proxy 11. In some embodiments, the SDN controller 13 further defines a routing rule 104 between the UE 17 (i.e., the source apparatus) and the broker 19 (i.e., the destination apparatus) and transmits the routing rule 104 to the SDN switch 15. Afterwards, if a packet transmitted by the UE 17 to the broker 19 is received by the SDN switch 15 again, the packet will be transmitted to the cross proxy 11 directly according to the routing rule 104, instead of being forwarded to the SDN controller 13, so that the related operations (as described below) are executed by the cross proxy 11 and the broker 19.

The cross proxy 11 receives the packet 102 from the SDN controller 13, translates the packet 102 into a packet 106, and transmits the packet 106 to the broker 19. Specifically, the cross proxy 11 generates the packet 106 by translating a first header of the packet 102 into a second header. It shall be appreciated that the packet 102 and the first header comprised therein conform to the first communication protocol (i.e., the source protocol), while the packet 106 and the second header comprised therein conform to the second communication protocol (i.e., the destination protocol).

After receiving the packet 106, the broker 19 learns from the packet 106 that the UE 17 requests data from the broker 19. Hence, the broker 19 transmits a packet 108 in response. The cross proxy 11 receives the packet 108 from the broker 19 (i.e., the destination apparatus) and translates the packet 108 into a packet 110. Specifically, the cross proxy 11 generates the packet 110 by translating a third header of the packet 108 into a fourth header. It shall be appreciated that the packet 108 and the third header comprised therein conform to the second communication protocol (i.e., the destination protocol), while the packet 110 and the fourth header comprised therein conform to the first communication protocol (i.e., the source protocol). Next, the cross proxy 11 transmits the packet 110 to the UE 17 and the UE 17 receives the packet 110 from the cross proxy 11.

Afterwards, if the UE 17 transmits other packets to request data from the broker 19, the SDN switch 15 will directly transmit the packets to the cross proxy 11 according to the routing rule 104 (i.e., the SDN switch 15 need not forward the packets to the SDN controller 13 again) after receiving the packets transmitted by the UE 17. Likewise, the cross proxy 11 and the broker 19 will execute similar operations after the packets transmitted by the SDN switch 15 is received by the cross proxy 11. The details will not be repeated herein.

According to the above descriptions, the SDN switch 15, the SDN controller 13, and the cross proxy 11 take charge of main related operations when the UE 17 requests data from an apparatus (i.e., the broker 19) adopting a different communication protocol. Briefly speaking, if the SDN switch 15 already has a routing rule, the packet transmitted by the UE 17 is processed according to the routing rule. If the SDN switch 15 has no routing rule, the packet from the UE 17 is forwarded to the SDN controller 13. The SDN controller 13 formulates a routing rule between the UE 17 and the destination apparatus (e.g., the broker 19), transmits the routing rule to the SDN switch 15 for subsequent use, and forwards the packet to the cross proxy 11. The cross proxy 11 then translates the packet transmitted between the UE 17 and the destination apparatus (e.g., the broker 19). Through the aforesaid operations, the UE 17 can adopt the first communication protocol that it originally adopts to communicate with apparatuses adopting other communication protocols, while the broker 19 also adopts the second communication protocol that it originally adopts to communicate with the UE 17. Therefore, a heterogeneous network environment that is capable of transparent translation and adopts a distributed architecture is achieved in the first embodiment.

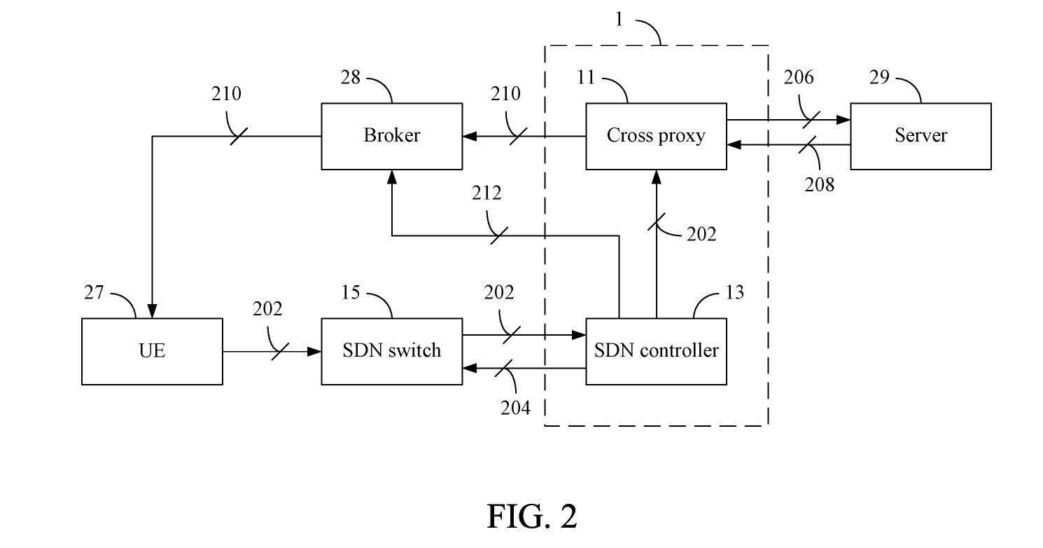

A second embodiment of the present invention is also the network communication protocol translation system 1, which is suitable for use in a heterogeneous network environment (e.g., a heterogeneous IoT environment) illustrated in FIG. 2. Similarly, the network communication protocol translation system 1 comprises a cross proxy 11 and a Software-Defined Network (SDN) controller 13. The heterogeneous network environment of the second embodiment comprises the network communication protocol translation system 1 (comprising the cross proxy 11 and the SDN controller 13), a SDN switch 15, a UE 27, a broker 28, and a server 29. It shall be appreciated that the operations executed by the cross proxy 11, the SDN controller 13, and the SDN switch 15 in the second embodiment are similar to those in the first embodiment, so the following description will focus on the differences between the two embodiments.

In this embodiment, both the UE 27 and the broker 28 adopt a first communication protocol, while the server 29 adopts a second communication protocol different from the first communication protocol. According to the specification of the first communication protocol, the UE 27 cannot request data from a server (not shown) directly. Instead, the UE 27 obtain from the broker 28 the data that the server previously pushed to the broker 28. For example, the first communication protocol may be a MQTT protocol, the UE 27 may be a MQTT apparatus, and the broker 28 may be a MQTT broker. According to the specification of the second communication protocol, a UE requests data from the server 29 directly and the server 29 transmits data to the UE only in response to a request from the UE. For example, the second communication protocol may be CoAP and the server 29 may be a CoAP server. In this embodiment, the UE 27 requests data from the sever 29, so the UE 27 may be termed as a source apparatus, the server 29 may be termed as a destination apparatus, the first communication protocol may be termed as a source protocol, and the second communication protocol may be termed as a destination protocol.

Similarly, the UE 27 learns that the heterogeneous network environment comprises the server 29 by broadcasting. The UE 27 transmits a packet 202 to request data from the server 29. The packet 202 records a name of the source protocol (i.e., the first communication protocol adopted by the UE 27), an address of the source device (i.e., the UE 27), a name of the destination protocol (i.e., the second communication protocol adopted by the server 29), and an address of the destination apparatus (i.e., the server 29).

Similarly, the SDN switch 15 receives the packet 202 transmitted by the UE 27 and parses the packet 202. After parsing the packet 202, the SDN switch 15 determines that the source protocol and the destination protocol recorded in the packet 202 are different and determines that the SDN switch 15 itself has no routing rule (not shown) between the UE 27 (i.e., the source apparatus) and the server 29 (i.e., the destination apparatus). In some embodiments, the SDN switch 15 makes the two determinations by parsing an extended URI in the packet 202. The extended URI comprises the name of the source protocol, the address of the source apparatus, the name of the destination protocol, and the address of the destination apparatus. The extended URI is an extension of the conventional URI.

The SDN switch 15 forwards the packet 202 to the SDN controller 13 after determining that the SDN switch 15 itself has no routing rule between the UE 27 (i.e., the source apparatus) and the server 29 (i.e., the destination apparatus). The SDN controller 13 receives the packet 202 from the SDN switch 15 and then forwards the packet 202 to the cross proxy 11. Besides, in this embodiment, the SDN controller 13 further transmits a trigger signal 212 to the broker 28. It shall be appreciated that the trigger signal 212 is configured to notify the broker 28 to receive push packet(s) pushed by the cross proxy 11 afterwards.

In some embodiments, the SDN controller 13 further defines a routing rule 204 between the UE 27 (i.e., the source apparatus) and the server 29 (i.e., the destination apparatus) and transmits the routing rule 204 to the SDN switch 15. Then, if a packet transmitted by the UE 27 to the server 29 is received by the SDN switch 15 again, the packet will be transmitted to the cross proxy 11 directly according to the routing rule 204 instead of being forwarded to the SDN controller 13 so that related operations (as described below) are executed by the cross proxy 11 and the sever 29.

The cross proxy 11 receives the packet 202 from the SDN controller 13, translates the packet 202 into a packet 206, and transmits the packet 206 to the server 29. Specifically, the cross proxy 11 generates the packet 206 by translating a first header of the packet 202 into a second header. It shall be appreciated that the packet 202 and the first header comprised therein conform to the first communication protocol (i.e., the source protocol), while the packet 206 and the second header comprised therein conform to the second communication protocol (i.e., the destination protocol).

After receiving the packet 206, the server 29 learns from the packet 206 that the UE 27 requests data from the server 29 and transmits a packet 108 in response. Specifically, the packet 208 is transmitted to the cross proxy 11 by the server 29 through pushing. The cross proxy 11 receives the packet 208 pushed by the server 29 (i.e., the destination apparatus) and translates the packet 208 into a packet 210. Specifically, the cross proxy 11 generates the packet 210 by translating a third header of the packet 208 into a fourth header. It shall be appreciated that the packet 208 and the third header comprised therein conform to the second communication protocol (i.e., the destination protocol), while the packet 210 and the fourth header comprised therein conform to the first communication protocol (i.e., the source protocol). Next, the cross proxy 11 transmits the packet 210 to the broker 28 and the broker 28 then forwards the packet 210 to the UE 27. The UE 27 receives the packet 210 from the broker 28.

Subsequently, if the UE 27 transmits other packets to request data from the server 29, the SDN switch 15 will transmit the packets directly to the cross proxy 11 according to the routing rule 204 (i.e., the SDN switch 15 need not forward the packets to the SDN controller 13 again) after receiving the packets transmitted by the UE 27. Likewise, the cross proxy 11 and the server 19 will execute similar operations after the packets transmitted by the SDN switch 15 is received by the cross proxy 11, and this will not be further described herein.

According to the above descriptions, the SDN switch 15, the SDN controller 13, and the cross proxy 11 take charge of main related operations when the UE 27 requests data from an apparatus (i.e., the server 29) adopting a different communication protocol. Briefly speaking, if the SDN switch 15 already has a routing rule, the packet transmitted by the UE 27 is processed directly according to the routing rule. If the SDN switch 15 has no routing rule, the packet from the UE 27 is forwarded to the SDN controller 13. The SDN controller 13 formulates a routing rule between the UE 27 and the destination apparatus (e.g., the broker 29), transmits the routing rule to the SDN switch 15 for subsequent use, and forwards the packet to the cross proxy 11. The cross proxy 11 then translates the packet transmitted between the UE 27 and the destination apparatus (e.g., the server 29). Through the aforesaid operations, the UE 27 can adopt the first communication protocol that it originally adopts to communicate with apparatuses adopting other communication protocols, and the server 29 also adopts the second communication protocol that it originally adopts to communicate with the UE 27. From the perspective of the server 29, the cross proxy 11 plays the role of a UE in the second communication protocol (e.g., CoAP). From the perspective of the UE 27, the cross proxy 11 plays the role of a server in the first communication protocol (e.g., MQTT). Hence, a heterogeneous network environment that is capable of transparent translation and adopts a distributed architecture is achieved in the second embodiment.

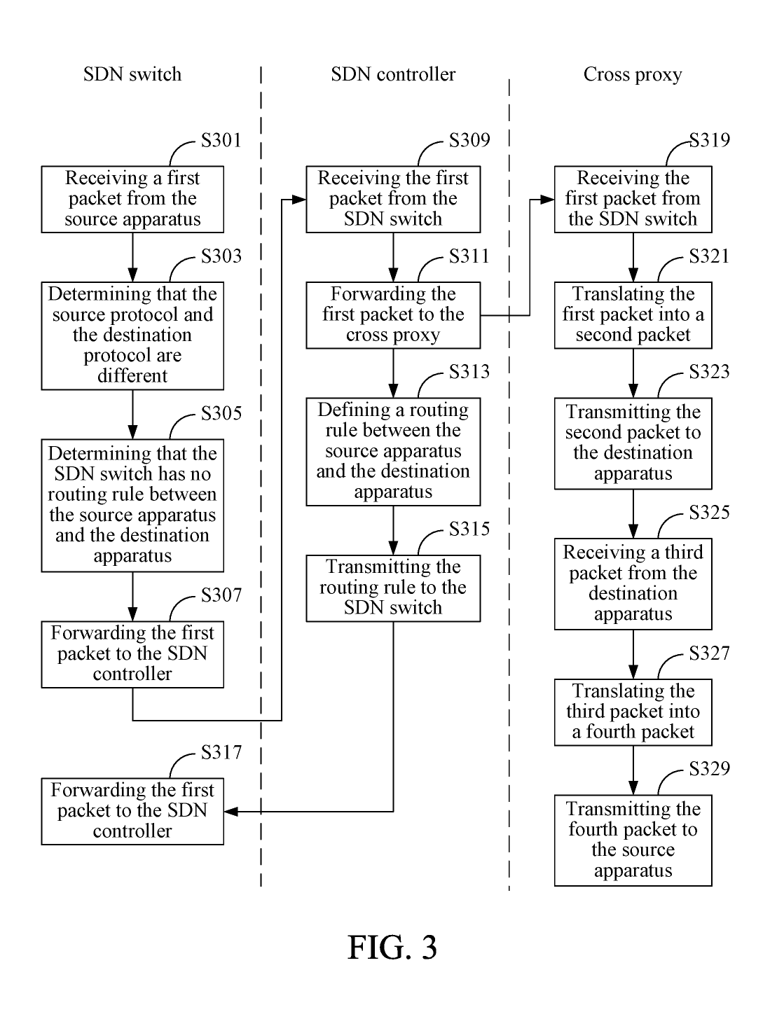

A third embodiment of the present invention is a network communication protocol translation method and a flowchart of which is illustrated in FIG. 3. The network communication protocol translation method of the third embodiment may be used in a heterogeneous network environment (e.g., a heterogeneous IoT environment). The heterogeneous network environment comprises a cross proxy, a SDN controller, a SDN switch, a UE, and a broker. For example, the cross proxy, the SDN controller, the SDN switch, the UE, and the broker may be the cross proxy 11, the SDN controller 13, the SDN switch 15, the UE 17, and the broker 19 of the first embodiment respectively.

In the third embodiment, the UE adopts a first communication protocol, while the broker adopts a second communication protocol different from the first communication protocol. According to the specification of the first communication protocol, the UE requests data from a server directly. For example, the first communication protocol may be CoAP and the UE may be a CoAP apparatus. According to the specification of the second communication protocol, a UE cannot request data from a server directly but has to obtain from the broker the data that the server previously pushed to the broker. For example, the second communication protocol may be a MQTT protocol and the broker may be a MQTT broker. In this embodiment, the UE transmits a first packet to request data from the broker, so the UE may be termed as a source apparatus, the broker may be termed as a destination apparatus, the first communication protocol may be termed as a source protocol, and the second communication protocol may be termed as a destination protocol.

In step S301, the first packet is received by the SDN switch from the UE. The first packet records a name of a source protocol (i.e., the first communication protocol) of the source apparatus and a name of the destination protocol (i.e., the second communication protocol) of the destination apparatus (i.e., the broker). In step S303, the first packet is parsed by the SDN switch to determine that the source protocol and the destination protocol are different. In some embodiments, the step S303 parses an extended Uniform Resource Identifier (URI) in the first packet, wherein the extended URI comprises the name of the source protocol and the name of the destination protocol. In step S305, the SDN switch determines that it has no routing rule between the source apparatus and the destination apparatus. Then, in step S307, the SDN switch forwards the first packet to the SDN controller.

In step S309, the first packet is received by the SDN controller from the SDN switch. In step S311, the first packet is forwarded by the SDN controller to the cross proxy. In some embodiments, the network communication protocol translation method further comprises steps S313, S315, and S317. In the step S313, a routing rule between the source apparatus and the destination apparatus is defined by the SDN controller. In the step S315, the routing rule is transmitted by the SDN controller to the SDN switch. In the step S317, the routing rule is received by the SDN switch from the SDN controller. It shall be appreciated that the SDN switch may execute the steps S313 and S315 before executing the step S311 in some embodiments.

Moreover, in step S319, the first packet is received by the cross proxy from the SDN controller. In step S321, a second packet is generated by the cross proxy by translating a first header of the first packet into a second header, where the first header conforms to the source protocol and the second header conforms to the destination protocol. In step S323, the second packet is transmitted by the cross proxy to the destination apparatus (i.e., the broker).

Upon receiving the second packet, the destination apparatus (i.e., the broker) generates a third packet in response. In step S325, the third packet is received by the cross proxy from the destination apparatus, where the third packet conforms to the destination protocol. In step S327, a fourth packet is generated by the cross proxy by translating a third header of the third packet into a fourth header, wherein the third header conforms to the destination protocol and the fourth header conforms to the source protocol. In step S329, the fourth packet is transmitted by the cross proxy to the source apparatus.

In addition to the aforesaid steps, the third embodiment can execute all the operations and steps, have the same functions, and deliver the same technical effects as set forth in the first embodiment. How the third embodiment executes these operations and steps, has the same functions, and delivers the same technical effects will be readily appreciated by those of ordinary skill in the art based on the explanation of the first embodiment and, thus, the details will not be further described herein.

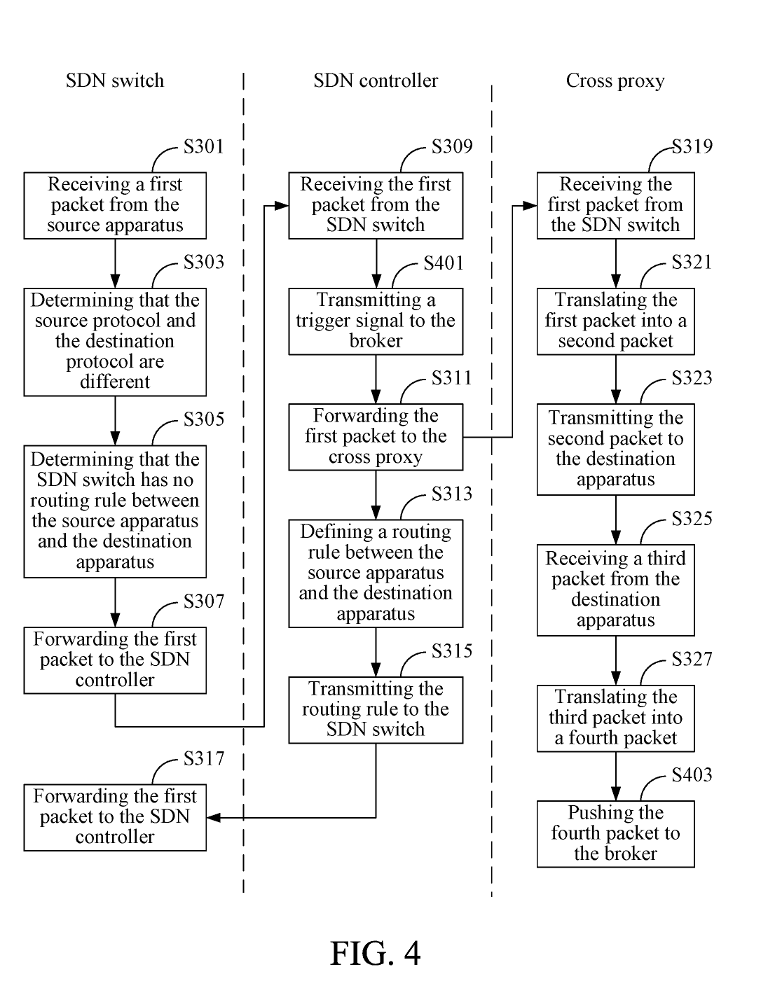

A fourth embodiment of the present invention is a network communication protocol translation method and a flowchart of which is illustrated in FIG. 4. The network communication protocol translation method of the fourth embodiment may be used in a heterogeneous network environment (e.g., a heterogeneous IoT environment). The heterogeneous network environment comprises a cross proxy, a SDN controller, a SDN switch, a UE, a broker, and a server. For example, the cross proxy, the SDN controller, the SDN switch, the UE, the broker, and the server may be the cross proxy 11, the SDN controller 13, the SDN switch 15, the UE 27, the broker 19, and the server 29 of the second embodiment respectively.

In the fourth embodiment, both the UE and the broker adopt a first communication protocol, while the server adopts a second communication protocol different from the first communication protocol. According to the specification of the first communication protocol, a UE cannot request data from a server directly. Instead, the UE conforming to the first communication protocol has to obtain from the broker the data that the server previously pushed to the broker. For example, the first communication protocol may be a MQTT protocol, the UE may be a MATT apparatus, and the broker may be a MQTT broker. According to the specification of the second communication protocol, the UE requests data from a server directly and the server transmits data to a UE only in response to the request of the UE. For example, the second communication protocol may be CoAP and the server may be a CoAP server. In this embodiment, the UE requests data from the server, so the UE may be termed as a source apparatus, the server may be termed as a destination apparatus, the first communication protocol may be termed as a source protocol, and the second communication protocol may be termed as a destination protocol.

Most steps executed by the fourth embodiment are the same as those of the third embodiment, so the following descriptions will be focused on the differences between the two embodiments. In this embodiment, the SDN switch executes the steps S301, S303, S305, and S307 first. Since the four steps are the same as those of the third embodiment, the details of them are not repeated herein. Next, the step S309 is executed by the SDN controller, which is also the same as that of the third embodiment and, thus, will not be further described herein.

Then, step S401 is executed to transmit a trigger signal by the SDN controller to the broker. The trigger signal is configured to notify the broker to receive at least one push packet pushed by the cross proxy. Afterwards, the steps S311, S313, and S315 are executed by the SDN controller. The three steps are the same as those of the third embodiment and, hence, they will not be further described herein. It shall be appreciated that, in other embodiments, the SDN controller may execute the steps S401, S311, S313, and S315 in other sequences as long as the step S315 is executed later than the step S313.

After the step S311 is executed by the SDN controller, the steps S319 to S327 are executed by the proxy server. Since these steps are the same as those of the third embodiment, they will not be further described herein. Then, step S403 is executed by the cross proxy to push the fourth packet to the broker. Thereafter, the fourth packet is transmitted to the source apparatus by the broker.

In addition to the aforesaid steps, the fourth embodiment can also execute all the operations and steps, have the same functions, and deliver the same technical effects as set forth in the second embodiment. How the fourth embodiment executes these operations and steps, has the same functions, and delivers the same technical effects will be readily appreciated by those of ordinary skill in the art based on the explanation of the second embodiment, and thus will not be further described herein.

It shall be appreciated that, in the specification and claims of the present invention, the terms “first” and “second” used in the first communication protocol and the second communication protocol are only intended to distinguish these communication protocols from each other. The terms “first,” “second,” “third,” and “fourth” used in the first packet, the second packet, the third packet, and the fourth packet are only intended to distinguish these packets from each other. Also, the terms “first,” “second,” “third,” and “fourth” used in the first header, the second header, the third header and the fourth header are only intended to distinguish these headers from each other.

According to the above descriptions, the SDN switch, the SDN controller, and the cross proxy take charge of main related operations when the UE requests data from an apparatus adopting a different communication protocol. If the SDN switch already has a routing rule, the packet transmitted by the UE is processed according to the routing rule. If the SDN switch has no routing rule, the packet from the UE is forwarded to the SDN controller. The SDN controller formulates a routing rule between the UE and the destination apparatus, transmits the routing rule to the SDN switch for subsequent use, and forwards the packet to the cross proxy. The cross proxy then translates the packet transmitted between the UE and the destination apparatus. Through the aforesaid operations, the UE can adopt its original communication protocol to communicate with apparatuses conforming to other communication protocols, while the server also adopts its original communication protocol to communicate with the UE. Therefore, a heterogeneous network environment that is capable of transparent translation and adopts a distributed architecture is achieved in the present invention.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A network communication protocol translation system, comprising:
a cross proxy; and
a software-defined network (SDN) controller, being configured to receive a first packet from an SDN switch and forward the first packet to the cross proxy, wherein the first packet records a name of a source protocol of a source apparatus and a name of a destination protocol of a destination apparatus and the source protocol and the destination protocol are different;
wherein the cross proxy generates a second packet by translating a first header of the first packet into a second header and transmits the second packet to the destination apparatus, wherein the first header conforms to the source protocol and the second header conforms to the destination protocol,
wherein the cross proxy server further receives a third packet from the destination apparatus, generates a fourth packet by translating a third header of the third packet into a fourth header, and transmits the fourth packet to the source apparatus, wherein the third header conforms to the destination protocol and the fourth header conforms to the source protocol.

2. The network communication protocol translation system of claim 1, further comprising the SDN switch, wherein the SDN switch determines that the source protocol and the destination protocol are different by parsing the first packet.

3. The network communication protocol translation system of claim 2, wherein the SDN switch parses an extended Uniform Resource Identifier (URI) in the first packet and the extended URI comprises the name of the source protocol and the name of the destination protocol.

4. The network communication protocol translation system of claim 2, wherein the SDN switch further determines that the SDN switch has no routing rule between the source apparatus and the destination apparatus and the SDN switch further forwards the first packet to the SDN controller after determining that the SDN switch have no routing rule between the source apparatus and the destination apparatus.

5. The network communication protocol translation system of claim 1, wherein the SDN controller further defines a routing rule between the source apparatus and the destination apparatus and transmits the routing rule to the SDN switch.

6. The network communication protocol translation system of claim 1, wherein the source apparatus is a Constrained Application Protocol (CoAP) apparatus and the destination apparatus is a Message Queuing Telemetry Transport (MQTT) broker.

7. The network communication protocol translation system of claim 1, wherein the SDN controller further transmits a trigger signal to a broker and the trigger signal notifies the broker to receive at least one push packet pushed by the cross proxy.

8. The network communication protocol translation system of claim 7, wherein the cross proxy pushes the fourth packet to the broker.

9. The network communication protocol translation system of claim 7, wherein the cross proxy transmits the fourth packet to the source apparatus via the broker.

10. The network communication protocol translation system of claim 7, wherein the source apparatus is a MQTT apparatus, the destination apparatus is a CoAP server, and the broker apparatus is a MQTT apparatus.

11. A network communication protocol translation method, comprising:
(a) receiving, by a software-defined network (SDN) controller, a first packet from a SDN switch;
(b) forwarding, by the SDN controller, the first packet to a cross proxy, wherein the first packet records a name of a source protocol of a source apparatus and a name of a destination protocol of a destination apparatus and the source protocol and the destination protocol are different;
(c) generating, by the cross proxy, a second packet by translating a first header of the first packet into a second header;
(d) transmitting, by the cross proxy, the second packet to the destination apparatus, wherein the first header conforms to the source protocol and the second header conforms to the destination protocol;
(e) receiving, by the cross proxy, a third packet from the destination apparatus;
(f) generating, by the cross proxy, a fourth packet by translating a third header of the third packet into a fourth header; and
(g) transmitting, by the cross proxy, the fourth packet to the source apparatus, wherein the third header conforms to the destination protocol and the fourth header conforms to the source protocol.

12. The network communication protocol translation method of claim 11, further comprising:
(h) determining, by the SDN switch, that the source protocol and the destination protocol are different by parsing the first packet.

13. The network communication protocol translation method of claim 12, wherein the step (h) parses an extended Uniform Resource Identifier (URI) in the first packet and the extended URI comprises the name of the source protocol and the name of the destination protocol.

14. The network communication protocol translation method of claim 12, further comprising:
determining, by the SDN switch, that the SDN switch have no routing rule between the source apparatus and the destination apparatus; and
forwarding, by the SDN switch, the first packet to the SDN controller after determining that the SDN switch have no routing rule between the source apparatus and the destination apparatus.

15. The network communication protocol translation method of claim 11, further comprising:
defining, by the SDN controller, a routing rule between the source apparatus and the destination apparatus; and
transmitting, by the SDN controller, the routing rule to the SDN switch.

16. The network communication protocol translation method of claim 11, wherein the source apparatus is a Constrained Application Protocol (CoAP) apparatus and the destination apparatus is a Message Queuing Telemetry Transport (MQTT) broker.

17. The network communication protocol translation method of claim 11, further comprising:
transmitting, by the SDN controller, a trigger signal to a broker, wherein the trigger signal notifies the broker to receive at least one push packet pushed by the cross proxy.

18. The network communication protocol translation method of claim 17, wherein the step (g) pushes the fourth packet to the broker.

19. The network communication protocol translation method of claim 17, wherein the step (g) transmits the fourth packet to the source apparatus via the broker by the cross proxy.

20. The network communication protocol translation method of claim 17, wherein the source apparatus is a MQTT apparatus, the destination apparatus is a CoAP server, and the broker apparatus is a MQTT apparatus.
